(19) United States
(12) Patent Application Publication
(10) Pub. No.: US 2025/0335040 A1
(43) Pub. Date: Oct. 30, 2025

(54) NAVIGATING THROUGH MENU OPTIONS USING HAND GESTURES

(71) Applicant: Snap Inc., Santa Monica, CA (US)

(72) Inventor: Jonathan Solichin, Arcadia, CA (US)

(21) Appl. No.: 18/646,673

(22) Filed: Apr. 25, 2024

(51) Int. Cl. G06F 3/01; G02B 27/01; G06T 19/00; G06V 40/20; H04W 76/14

(52) U.S. Cl. CPC G06F 3/017; G02B 27/017; G06T 19/006; G06V 40/28; H04W 76/14; G02B 2027/0138

(57) ABSTRACT

Aspects of the present disclosure involve a system for navigating menus and selecting options using hand gestures. The system detects a first hand gesture depicted in a video, the first hand gesture performed by a first hand of a person. The system, in response to detecting the first hand gesture, accesses a first menu comprising a plurality of options. The system detects, within a threshold period of time from when the first hand gesture is detected, a second hand gesture depicted in the video. The system, in response to detecting, within the threshold period of time from when the first hand gesture is detected, the second hand gesture, performs an operation associated with an individual option of the plurality of options of the first menu.

### TECHNICAL FIELD

The present disclosure relates generally to generating images and providing try-on experiences using an interaction application.

### BACKGROUND

Augmented reality (AR) is a modification of a real-world environment with the addition or overlay of virtual content. For example, in virtual reality (VR), a user is completely immersed in a virtual world, whereas in AR, the user is immersed in a world where virtual objects are combined or superimposed on the real world. An AR system aims to generate and present virtual objects that interact realistically with a real-world environment and with each other. Examples of AR applications can include single or multiple player video games, instant messaging systems, and the like.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of an interaction application, in accordance with some examples.

FIG. 3 is a diagrammatic representation of a data structure as maintained in a database, in accordance with some examples.

FIG. 4 is a diagrammatic representation of a message, in accordance with some examples.

FIG. 5 is a block diagram showing an example hand gesture based menu navigation system, according to some examples.

FIG. 6 is a block diagram showing an example set of tables, according to some examples.

FIG. 7 is a diagrammatic representation of inputs and outputs of the hand gesture based menu navigation system, in accordance with some examples.

FIG. 8 is a flowchart illustrating example operations of the hand gesture based menu navigation system, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

FIG. 11 illustrates a system in which the head-wearable apparatus, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples. It will be evident, however, to those skilled in the art, that examples may be practiced without these specific details. In general, well-known instruction instances, protocols, structures, and techniques are not necessarily shown in detail.

AR and VR systems have made significant strides in recent years, offering immersive experiences that blend digital content with the real world. One of the primary interaction methods in AR/VR environments involves users pointing with a finger or hand to select virtual options and navigate through menus. This gesture-based interface allows for a natural and intuitive way for users to interact with AR/VR applications, eliminating the need for physical controllers or peripherals. However, despite the advancements, this interaction paradigm has its limitations, particularly when it comes to efficiency and resource utilization. For instance, when users need to reach menu options or perform operations within certain applications, they often have to navigate through multiple layers of menus. This can be time-consuming and cumbersome, especially if the user is trying to access a function that is nested deep within the menu hierarchy. The process of pointing and selecting through each level not only slows down the interaction but can also lead to fatigue, as the user must continuously perform the pointing gesture.

The lack of a physical keyboard or an equivalent input device in most AR systems exacerbates this issue. Keyboards allow for the use of shortcuts, which can significantly speed up the process of navigating software and reaching desired functions. For example, on a traditional computer, a user can quickly press a combination of keys to execute a command or jump to a specific feature without having to go through a series of menus. In AR, the absence of such shortcuts means that users are often forced to take the longer route to perform actions that could otherwise be accomplished with a simple key press. This inefficiency can lead to a waste of resources, both in terms of the user's time and the system's processing power. Every additional step in the menu navigation process requires computational resources to render the visual elements and register the user's selections. When multiplied by the number of users and the frequency of interactions, this can amount to a significant expenditure of energy and processing capacity that could be better utilized elsewhere.

To address these inefficiencies, AR system developers can rely on voice commands, eye tracking, and machine learning algorithms that predict user intent and surface commonly used functions more prominently. While these developments hold promise, the challenge remains to create an interaction model for AR that combines the intuitiveness of gesture-based controls with the efficiency of traditional input methods like the keyboard.

The disclosed techniques address these issues and improve the efficiency of using an electronic device, such as a user system, by providing an AR/VR system that allows a user to use a combination of hand gestures to navigate complex menu hierarchies and reach certain menu options. In some cases, a single hand can perform multiple gestures each within a specified time interval of each other (similar to sign language). The combination of these multiple hand gestures performed by the signal hand can be mapped to certain functions, operations, applications, and/or menus that are then accessed and/or launched in response to detecting the combination of multiple hand gestures. This allows a user to very quickly and efficiently access features of the user device or applications implemented by the user device much like having a keyboard with dedicated shortcuts. This cuts down on the amount of resources and battery power consumed by the AR/VR system which improves the efficiencies of the device. In some cases, the multiple gestures that are detected can be performed by two hands of the user, each gesture being performed within a specified threshold period of time of each other. This can simplify the process of performing gestures to perform certain operations and further improves the overall functioning of the device.

This enhances the overall experience and reduces the amount of resources needed to accomplish a task. Namely, the user does not need to continuously navigate between different pages of information (e.g., a page of the online graphical user interface (GUI) of fashion items and a page of the AR experience) and rather can access a desired function very quickly with a simple hand gesture or combination of hand gestures. In this way, the overall user experience is improved and the amount of resources needed to accomplish a task is reduced.

### Networked Computing Environment

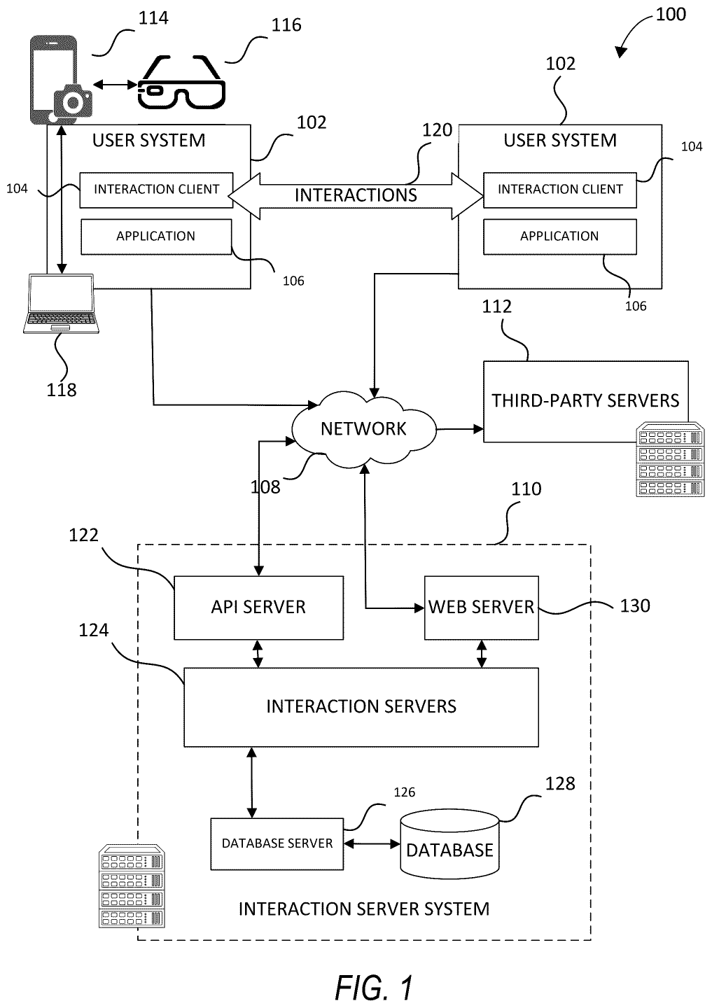

FIG. 1 is a block diagram showing an example interaction system 100 for facilitating interactions (e.g., exchanging text messages, conducting text audio and video calls, or playing games) over a network. The interaction system 100 includes multiple client systems 102 (also referred to herein as user systems 102), each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110, and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an API server 122 is coupled to, and provides programmatic interfaces to, interaction servers 124, making the functions of the interaction servers 124 accessible to interaction clients 104, other applications 106, and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over Hypertext Transfer Protocol (HTTP) and several other related protocols.

The API server 122 receives and transmits interaction data (e.g., commands and message payloads) between the interaction servers 124, the client systems 102 (and, for example, interaction clients 104 and other applications 106), and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

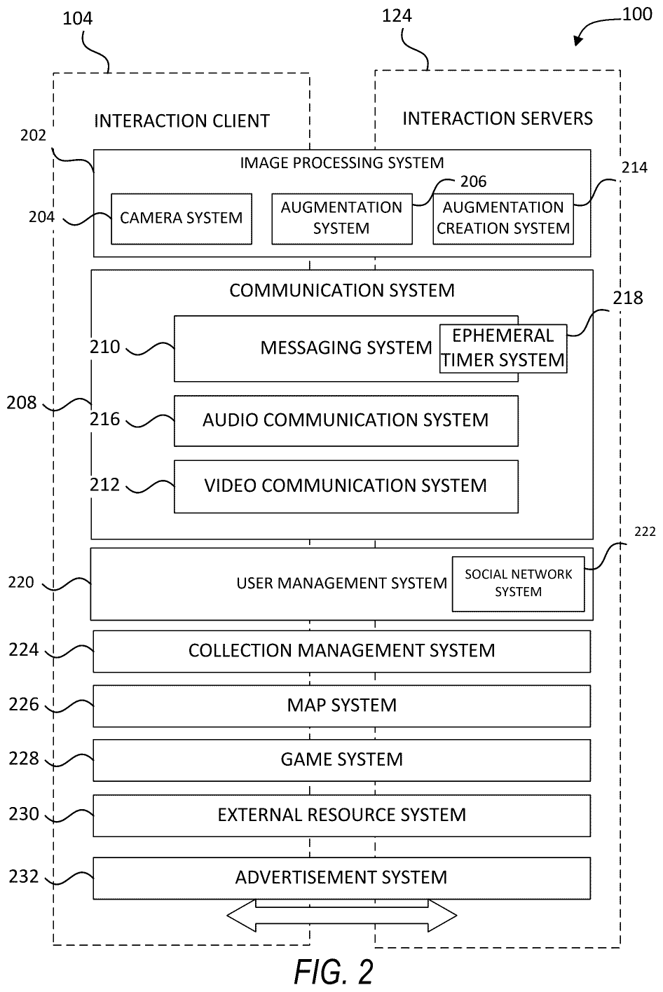

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a UI of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface), such as using a combination of single hand or multiple hand gestures performed within a threshold period of time of each other.

### System Architecture

FIG. 2 is a block diagram illustrating further details regarding the interaction system 100, according to some examples. Specifically, the interaction system 100 is shown to comprise the interaction client 104 and the interaction servers 124.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

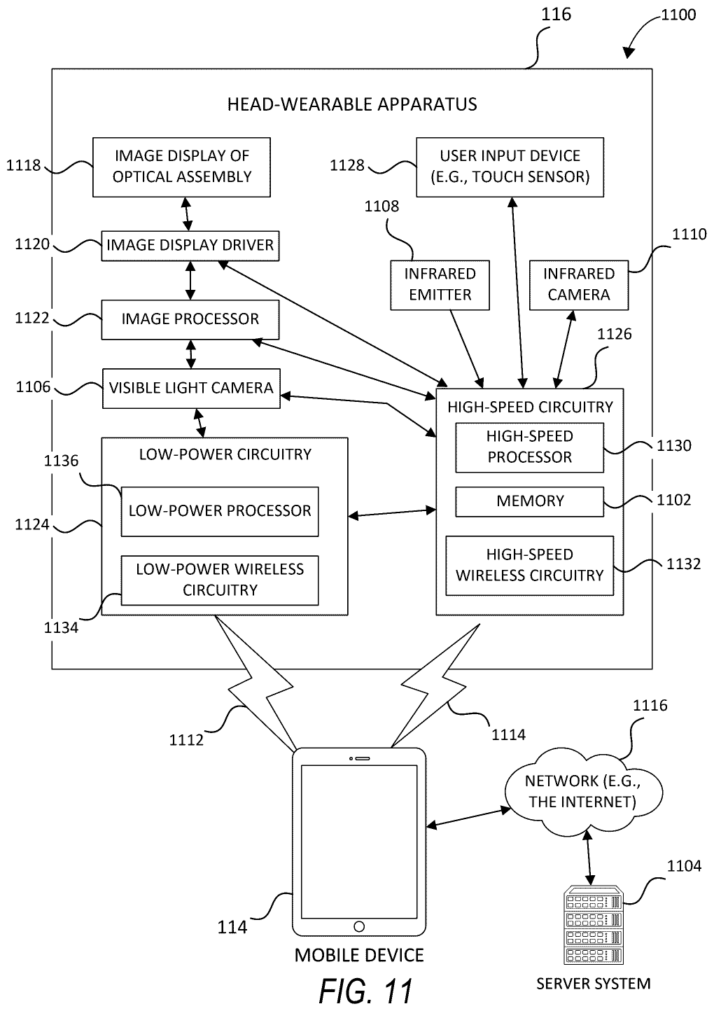

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 1102 (shown in FIG. 11) of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of a communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

An augmentation creation system 214 supports AR developer platforms and includes an application for content creators (e.g., artists and developers) to create and publish augmentations (e.g., AR experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles and includes a social network system 222 that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the UI of the interaction client 104. The collection management system 224 includes a curation function that allows a collection manager to manage and curate a particular collection of content. For example, the curation interface enables an event organizer to curate a collection of content relating to a specific event (e.g., to delete inappropriate content or redundant messages). Additionally, the collection management system 224 employs machine vision (or image recognition technology) and content rules to curate a content collection automatically. In certain examples, compensation may be paid to a user to include user-generated content into a collection. In such cases, the collection management system 224 operates to automatically make payments to such users to use their content.

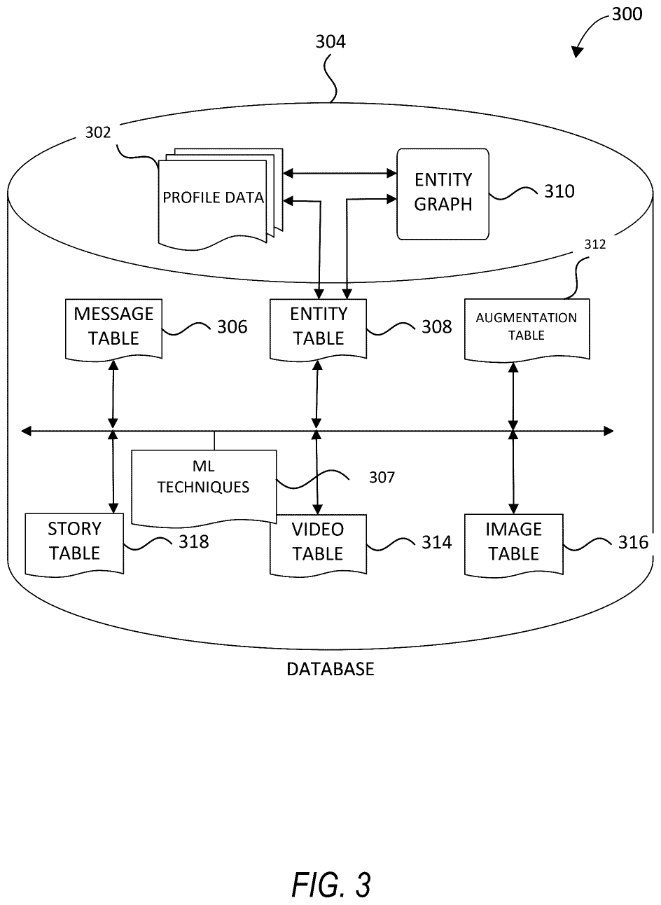

A map system 226 provides various geographic location functions and supports the presentation of map-based media content and messages by the interaction client 104. For example, the map system 226 enables the display of user icons or avatars (e.g., stored in profile data 302, shown in FIG. 3) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 228 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 230 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another GUI of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional (2D) avatars of users with or without different avatar characteristics). As another example, external resources that include small-scale versions of applications (e.g., web-based versions of applications) are provided with access to a second type of user data (e.g., payment information, 2D avatars of users, three-dimensional (3D) avatars of users, and avatars with various avatar characteristics). Avatar characteristics include different ways to customize a look and feel of an avatar, such as different poses, facial features, clothing, and so forth.

An advertisement system 232 operationally enables the purchasing of advertisements by third parties for presentation to end-users via the interaction clients 104 and also handles the delivery and presentation of these advertisements.

A hand gesture based menu navigation system 500 detects a first hand gesture depicted in a video, the first hand gesture performed by a first hand of a person. The hand gesture based menu navigation system 500, in response to detecting the first hand gesture, accesses a first menu comprising a plurality of options. The hand gesture based menu navigation system 500 detects, within a threshold period of time from when the first hand gesture is detected, a second hand gesture depicted in the video. The hand gesture based menu navigation system 500, in response to detecting, within the threshold period of time from when the first hand gesture is detected, the second hand gesture, performs an operation associated with an individual option of the plurality of options of the first menu.

### Data Architecture

FIG. 3 is a schematic diagram illustrating data structures 300, which may be stored in a database 304 of the interaction server system 110, according to certain examples. While the content of the database 304 is shown to comprise multiple tables, it will be appreciated that the data could be stored in other types of data structures (e.g., as an object-oriented database).

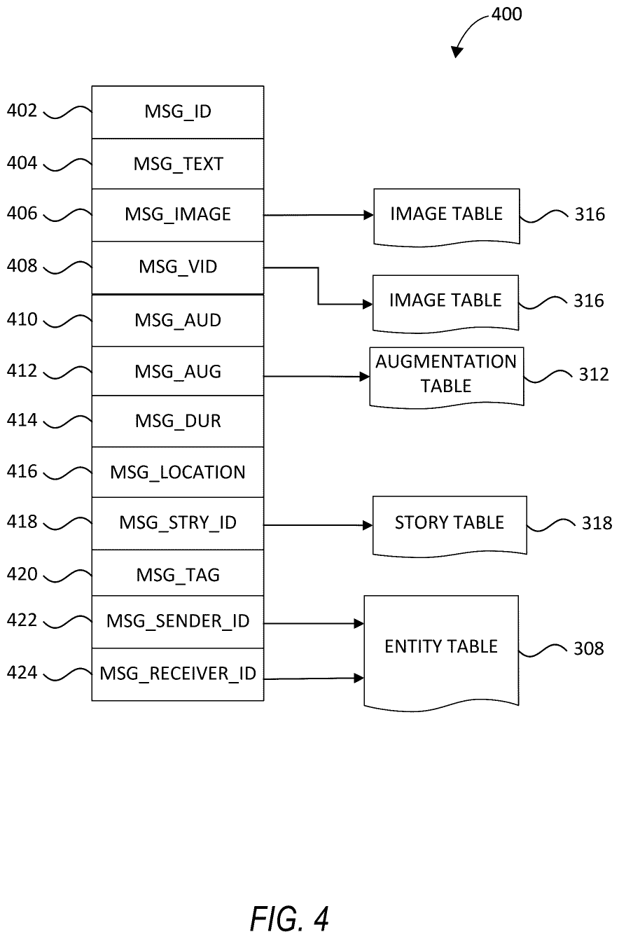

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 4.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location.

For example, geolocation filters specific to a neighborhood or special location may be presented within a UI by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes AR content items (e.g., corresponding to applying “lenses” or AR experiences). An AR content item may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the UI of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a UI of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

The databases 304 also include trained machine learning technique(s)/model(s) 307 that stores parameters of one or more machine learning models that have been trained during training of the hand gesture based menu navigation system 500. For example, trained machine learning technique(s)/model(s) 307 stores the trained parameters of one or more artificial neural network machine learning models or techniques.

### Data Communications Architecture

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a UI of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the story table 318) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a story table 318, and values stored within the message sender identifier 422 and the message receiver identifier 424 may point to user records stored within an entity table 308.

### Hand Gesture Based Menu Navigation System

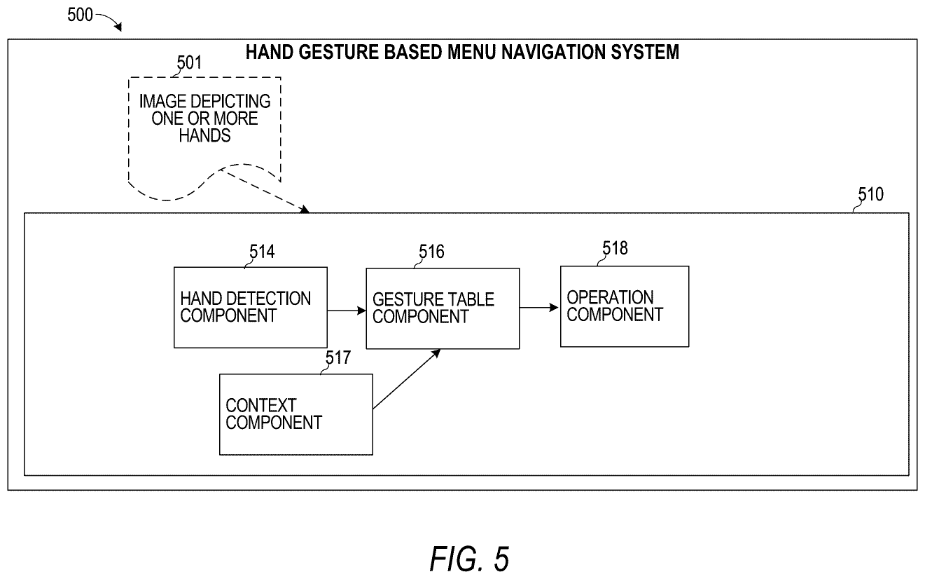

FIG. 5 is a block diagram showing an example hand gesture based menu navigation system 500, according to some examples. The hand gesture based menu navigation system 500 includes a set of components 510 that operate on a set of input data (e.g., an image 501 (or video including one or more frames) depicting one or more hands of a person in a real-world environment). The hand gesture based menu navigation system 500 includes a hand detection component 514, a gesture table component 516, a context component 517, and an operation component 518. All or some of the components of the hand gesture based menu navigation system 500 can be implemented by a server, in which case, the image 501 is provided to the server by the user system 102. In some cases, some or all of the components of the hand gesture based menu navigation system 500 can be implemented by the user system 102 or can be distributed across a set of user systems 102. Any one of the components of FIG. 5 can be combined into a single component or device.

In some cases, the hand gesture based menu navigation system 500 activates a front-facing or rear-facing camera feed of the user system 102. The hand gesture based menu navigation system 500 receives and/or accesses a real-time camera feed from the front-facing or rear-facing camera of the user system 102. The camera feed can depict a real-world person or a body part of a real-world person, such as a face, torso, arms, legs, hips, hands or any other body part or body parts of the person. The hand gesture based menu navigation system 500 provides the camera feed that includes one or more frames that depict the person or body part of the person to the hand detection component 514.

The hand detection component 514 implements one or more machine learning models (e.g., one or more neural networks) that have been trained to detect and track hands of one or more persons in one or more video frames. For example, during training, the machine learning model of the hand detection component 514 receives a given training image (or video) from a plurality of training images (or videos) that depict one or more hands of a person. The plurality of training images is associated with corresponding ground truth markers or indications of the one or more hands of the person depicted in the training images and can be received or accessed from training image data stored in data structures 300. The hand detection component 514 applies one or more machine learning models to a given training image. The hand detection component 514 generates estimated tracking information and gesture recognition information for the one or more hands of the person depicted in the given training image.

The hand detection component 514 obtains known or predetermined ground-truth tracking information and gesture recognition information corresponding to the given training image. The hand detection component 514 compares (computes a deviation between) the estimated tracking information and gesture recognition information with the ground truth tracking information and gesture recognition information. Based on a difference threshold of the comparison (or deviation), the hand detection component 514 updates one or more coefficients or parameters and obtains one or more additional training images from the training data.

After a specified number of epochs or batches of training images have been processed and/or when a difference threshold (or deviation) (computed as a function of a difference or deviation between the estimated tracking information and the ground-truth tracking information) reaches a specified value, the hand detection component 514 completes training, and the parameters and coefficients of the hand detection component 514 are stored as a trained machine learning technique (or model).

In some examples, the hand detection component 514 is used to detect one or more hands of a persons and/or body parts depicted in an image/video of a real-world environment. The hand detection component 514 provides tracking information and gesture recognition information for hands of the person and/or body parts estimated from the captured images/video to the gesture table component 516. The gesture table component 516 can then search one or more tables to identify a menu, application, option, operation, and/or feature that is associated with the detected gesture recognition information. In some cases, the gesture recognition information corresponds to multiple gestures performed by a single hand within a threshold period of time (e.g., within 3 seconds). In some cases, the gesture recognition information corresponds to multiple gestures performed by first and second hands within a threshold period of time (e.g., within 3 seconds), such as a first gesture performed by a first hand followed by a second gesture performed by a second hand within the threshold period of time. The different gestures stored in the one or more tables can each correspond to a different combination of the gestures performed by the single hand and/or performed by the multiple hands.

In some examples, the menu, application, option, operation, and/or feature that is retrieved from the table can be based on a current context of the user system 102. Specifically, the gesture table component 516 can store multiple tables each associated with a different context of the user system 102. The same gesture or combination of gestures performed by the hands can cause different options, menus, and/or operations to be performed based on the current context. For example, the current context can be determined by the context component 517. The current context can indicate what application is currently being executed in the foreground of the user system 102 (e.g., whether the current application is the operating system or some other application, such as a sports application, messaging application, or stock quotes application).

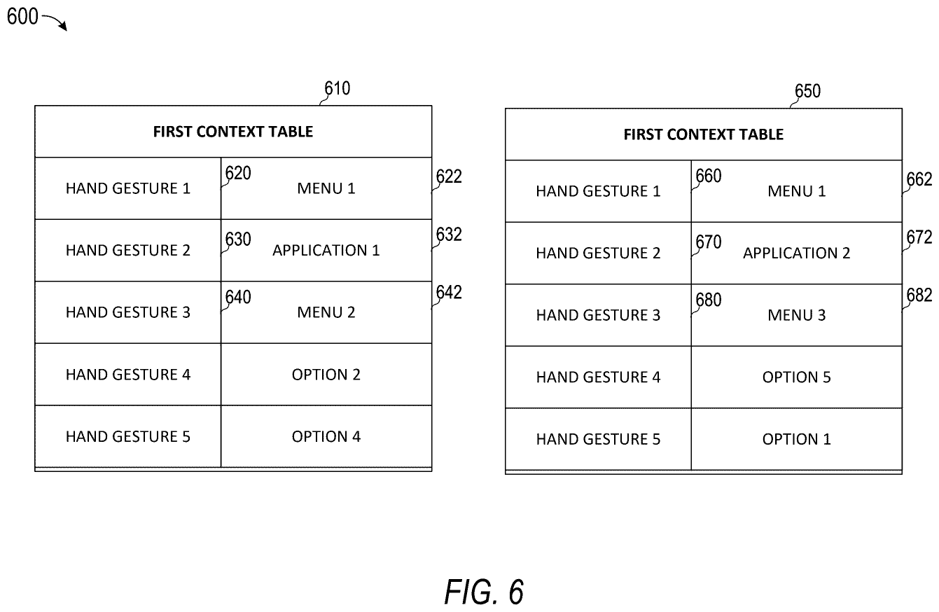

The context component 517 can identify the current context of the user system 102 and provide the indication of the current context to the gesture table component 516. The gesture table component 516 can then select a particular table from multiple tables that corresponds to the current context. For example, as shown in FIG. 6, the gesture table component 516 can store multiple tables 600. The multiple tables can include a first context table 610 and a second context table 650. The menus can be multiple layers deep. In such cases, one table can be linked to another table of gestures. When one table is activated, a particular gesture (corresponding to selection of an option) can be used to activated a nested menu that is associated with another table of gestures. In some cases, the context component 517 can automatically activate a next table or menu by predicting what the next gesture the user will be perform will be. For example, the context component 517 can determine that a first gesture in a sequence is being performed. In response, the context component 517 can automatically perform the operation associated with the second gesture in the sequence before the second gesture is performed or completed.

The first context table 610 can correspond to a first context of the user system 102 and the second context table 650 can correspond to a second context of the user system 102. For example, the first context table 610 can include a first hand gesture 620 that is associated with a first menu 622. In response to the hand detection component 514 detecting a hand gesture that corresponds to the first hand gesture 620 and in response to the first context table 610 being accessed (based on the current context of the user system 102 matching the first context), the gesture table component 516 can select to launch the first menu 622. The first hand gesture 620 can correspond to a particular symbol performed by a first hand, a sequence of symbols performed by the first hand within a threshold period of time (e.g., 3 seconds), and/or a sequence of symbols performed using the first hand and a second hand within a specified threshold (e.g., 2 seconds).

The first menu 622 can be presented as an overlay on a real-world environment being perceived through a display or lenses of the user system 102. The first menu 622 can include various options that can be selected. In some cases, the first menu 622 can present in association with each of the options a different hand gesture that can be performed to access or launch the particular option. For example, the first menu 622 can include a first option that is associated with one type of hand gesture (performed by the first hand and/or by the second hand) and a second option that is associated with another type of hand gesture (performed by the first hand and/or by the second hand). An icon, animation, and/or video can be presented next to or adjacent to the first option to represent the hand gesture that is associated with the first option. Similarly, another icon, animation, and/or video can be presented next to or adjacent to the second option to represent the hand gesture that is associated with the second option. This allows the user to learn the gestures that can be performed to reach certain menu options or perform certain operations. In some cases, after the first menu 622 is presented a certain number of times over a threshold period of time (e.g., two weeks), the icons representing the different hand gestures can be excluded from being presented next to the corresponding options.

The first context table 610 can include a second hand gesture 630 that is associated with a first application 632. In response to the hand detection component 514 detecting a hand gesture that corresponds to the second hand gesture 630 and in response to the first context table 610 being accessed (based on the current context of the user system 102 matching the first context), the gesture table component 516 can select to launch the first application 632. This way, if the user system 102 is currently presenting a UI of an operating system or second application, the user system 102 can quickly launch the first application 632 in response to detecting the second hand gesture 630 being performed (e.g., by one hand or multiple hands of the person or user).

The first context table 610 can include a third hand gesture 640 that is associated with a second menu 642. In response to the hand detection component 514 detecting a hand gesture that corresponds to the third hand gesture 640 and in response to the first context table 610 being accessed (based on the current context of the user system 102 matching the first context), the gesture table component 516 can select to launch the second menu 642. Similar to the presentation or access to the first menu 622, a list of menu options of the second menu 642 and corresponding hand gestures to access the different menu options can be presented as an overlay as a virtual object over a real-world environment being perceived by the user through the user system 102.

In some examples, in response to the context component 517 determining that the current context of the user system 102 corresponds to the first context, the context component 517 can present a virtual or AR object that represents the first context. The virtual or AR object can be presented as an overlay on a real-world environment being depicted or seen by the user of the user system 102. The virtual or AR object can be presented in response to receiving an indication from the hand detection component 514 that one or more hands of the user are currently being depicted in one or more frames of a captured video in real time. In some cases, the virtual or AR object can include an AR glove having a first color that is associated with the first context. The AR glove can be overlaid on a portion of one or more hands of the user depicted in the video and can track movement of the hand. Because the glove is presented in the first color, the user is informed about which of the multiple tables 600 is currently being accessed to control operations and perform selections of different menus or features.

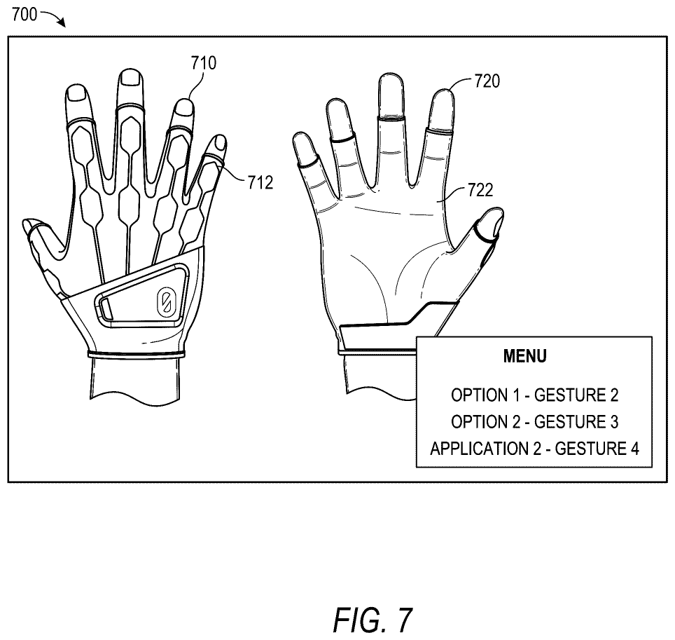

For example, as shown in FIG. 7, a video 700 of a real-world environment can be captured by the user system 102. The video 700 can depict a first hand 710 and a second hand 720. The context component 517 can determine that the current context of the user system 102 corresponds to the first context. In response, the context component 517 can present an AR glove 712 over the first hand 710 and/or an AR glove 722 of the second hand 720. The color or visual attribute of the AR glove 712 can correspond to or represent the first context. Gestures performed by the first hand 710 can trigger operations or options mapped to gestures in the first context. In some cases, the color or visual attribute of the AR glove 722 can correspond to or represent the second context. Gestures performed by the second hand 720 can trigger operations or options mapped to gestures in the second context. This way, the user can control different contexts using different gestures performed by the user's hands.

In some cases, in response to detecting a gesture performed by the first hand 710, the hand gesture based menu navigation system 500 can present a menu that corresponds to the gesture. The menu can include a list of options or application and can display animations, icons, descriptions, images or videos representing the gestures that can be performed by the second hand 720 and/or the first hand 710 to execute an operation corresponding the option or application. For example, option 1 can be executed in response to a second gesture being performed, such as by the hand over which the AR glove with the color corresponding to the menu is presented. The AR glove 722 can be presented on the second hand 720 in response to detecting the gesture performed by the first hand 710 that caused the presentation of the menu.

In some cases, the menu that is presented can include a visual attribute that matches the visual attribute of the AR glove 722. For example, the menu can be presented in a blue color and the AR glove 722 can be presented in a blue color. This indicates to the user that performance of the gestures listed in the menu by the second hand 720 (the hand over which the AR glove 722 is presented) can trigger the operation of the options listed in the menu. For example, if the second hand 720 performs gesture 3 listed in the menu, the option 2 operation can be performed because the AR glove 722 is presented over the second hand 720 and not over the first hand 710. If the first hand 710 performs gesture 3 other operations can be performed and none of the operations associated with the options listed in the menu is performed. This is because the menu or context is mapped to the second hand 720 and not the first hand 710. In some cases, the AR glove 712 and the AR glove 722 can both be presented with the same visual attribute (e.g., blue in color). This indicates that a combination of gestures performed by the second hand 720 and the first hand 710 can trigger performing the corresponding options listed in the menu.

In some cases, the context component 517 can detect input (e.g., via one or more hand gestures) to activate a second context. For example, in response to detecting the second hand gesture 630, the first application 632 can be launched which switches the current context to the second context. In such cases, the context component 517 can change a visual attribute of the virtual or AR object from the first color to the second color. This indicates to the user that gestures performed by the hands of the user are associated with the second context table 650. This way, the same hand gesture performed by the user or person can cause different menus, options, features, or applications to be accessed based on the current context (e.g., which application is in the foreground) of the user system 102.

The second context table 650 can include a first hand gesture 660 that is associated with a first menu 662 of the first application. The first menu 662 can be different from the first menu 622 associated with the first hand gesture 620. The first hand gesture 660 can be the same gesture as the first hand gesture 620 or can be a different gesture from the first hand gesture 620. In response to the hand detection component 514 detecting a hand gesture that corresponds to the first hand gesture 660 and in response to the second context table 650 being accessed (based on the current context of the user system 102 matching the first context), the gesture table component 516 can select to launch the first menu 662 (which can be a submenu of the first menu 622) and can include a different set of options from the options of the first menu 622. The first hand gesture 660 can correspond to a particular symbol performed by a first hand, a sequence of symbols performed by the first hand within a threshold period of time (e.g., 3 seconds), and/or a sequence of symbols performed using the first hand and a second hand within a specified threshold (e.g., 2 seconds).

The first context table 610 can include a second hand gesture 670 that is associated with a second application 672. In response to the hand detection component 514 detecting a hand gesture that corresponds to the second hand gesture 670 and in response to the second context table 650 being accessed (based on the current context of the user system 102 matching the second context), the gesture table component 516 can select to launch the second application 672. This way, if the user system 102 is currently presenting a UI of an operating system or first application, the user system 102 can quickly launch the second application 672 in response to detecting the second hand gesture 630 being performed (e.g., by one hand or multiple hands of the person or user).

The first context table 610 can include a third hand gesture 680 that is associated with a third menu 682. In response to the hand detection component 514 detecting a hand gesture that corresponds to the third hand gesture 680 and in response to the second context table 650 being accessed (based on the current context of the user system 102 matching the first context), the gesture table component 516 can select to launch the third menu 682. Similar to the presentation or access to the first menu 622, a list of menu options of the third menu 682 and corresponding hand gestures to access the different menu options can be presented as an overlay as a virtual object over a real-world environment being perceived by the user through the user system 102.

For example, the hand detection component 514 can detect a first hand performing a gesture in which the hand is in an open hand configuration and can detect a second hand performing a gesture in which the hand is performing a thumbs up gesture. In response, the hand gesture based menu navigation system 500 launches a first menu that is associated with this combination of gestures. The hand detection component 514 can then detect that the second hand switched to performing a thumbs down gesture. In such cases, the hand gesture based menu navigation system 500 can start navigating a cursor down the first menu through the options of the menu. The second hand can continue performing the thumbs down gesture while the first hand remains visible in the open hand configuration. In response to determining that the second hand switches to performing a thumbs up gesture, the hand gesture based menu navigation system 500 can switch to navigating the cursor up the first menu through the options.

In some examples, the hand detection component 514 can determine that the first hand is performing a gesture that is associated with a cultural symbol The hand detection component 514 can communicate with the gesture table component 516 to identify the cultural symbol and obtain the corresponding action or operation associated with the cultural symbol. The gesture table component 516 can then instruct the operation component 518 to perform the operation corresponding to the cultural symbol. Any function that is selected or mapped to the gesture identified from the multiple tables 600 can be provided to the operation component 518 for execution. For example, the hand gesture can represent a dog and, in such cases, a dog application can be launched by the user system 102.

In some examples, through a series of gestures users can quickly detail a specific request. In one example, numerical finger gestures can be detected as the hand gestures by the hand gesture based menu navigation system 500 and used to go through a simple OS features, functions, and menus. Namely, a hand gesture that represents the numerical value one (e.g., by raising only one finger while the rest remain lowered) may represent the menu item “weather.” In response to the hand gesture based menu navigation system 500 detecting the hand gesture representing the numerical value one, the hand gesture based menu navigation system 500 accesses the weather menu. Immediately (e.g., within three seconds) of detecting the numerical value one in the hand gesture, the hand gesture based menu navigation system 500 can detect another hand gesture, such as the numerical value one again. In response, the hand gesture based menu navigation system 500 can launch or access the temperature feature of the weather application and present temperature information as a virtual object in the user system 102. Alternatively, the hand gesture based menu navigation system 500 can detect the numerical value two as immediately following the numerical value one. In such cases, can launch or access the precipitation feature of the weather application and present precipitation information as a virtual object in the user system 102.

In some cases, instead of detecting the number value gesture initially, the hand gesture based menu navigation system 500 can detect that the hand gesture corresponds to the numerical value 2 (e.g., the hand gesture includes two fingers being raised while the rest are lowered). In response, the hand gesture based menu navigation system 500 launches the “messaging” application. At this point, the same numerical value gesture can trigger a different set of behaviors. For example, immediately (e.g., within three seconds) of detecting the numerical value two in the hand gesture, the hand gesture based menu navigation system 500 can detect another hand gesture, such as the numerical value one. In response, the hand gesture based menu navigation system 500 can present new messages of the messaging application. Alternatively, the hand gesture based menu navigation system 500 can detect another hand gesture, such as the numerical value two again. In response, the hand gesture based menu navigation system 500 can present read messages. Once the new messages are presented, additional hand gestures can be detected to select different items from the list of new messages. For example, additional numerical value gestures can trigger options or operations, such as reply, mark as read, and so forth. Thus, a user is able to more quickly and accurately dive through various interactions since the speed is limited only by their ability to move their physical hands to such gestures (rather than moving a mouse and pointing to various screen elements).

In some cases, more complex expressions can be used to allow users to make more detailed requests. For example, the hand gesture based menu navigation system 500 can detect a gesture in which a left hand faces up, and the right hand gesturing “R” (e.g., in sign language). In such cases, the hand gesture based menu navigation system 500 can cause the messaging application to execute a “reply all” operation. If the left hand faces down, and the right hand makes an “R” gesture can cause the messaging application to trigger a “Reply” operation. Such a system can be an analog to the “cmd” “option” “ctrl” key modifiers on a keyboard.

In some examples, a magnitude or intensity of a hand gesture being performed can vary the associated option. For example, the hand gesture based menu navigation system 500 can detect that the hand is swinging in a particular direction at a particular rate as the gesture. This can cause the hand gesture based menu navigation system 500 to perform a first operation (e.g., increase the volume at a first rate). The hand gesture based menu navigation system 500 can detect that the hand is swinging in the particular direction at a greater rate as the gesture. This can cause the hand gesture based menu navigation system 500 to perform a second operation (e.g., increase the volume at a second greater rate).

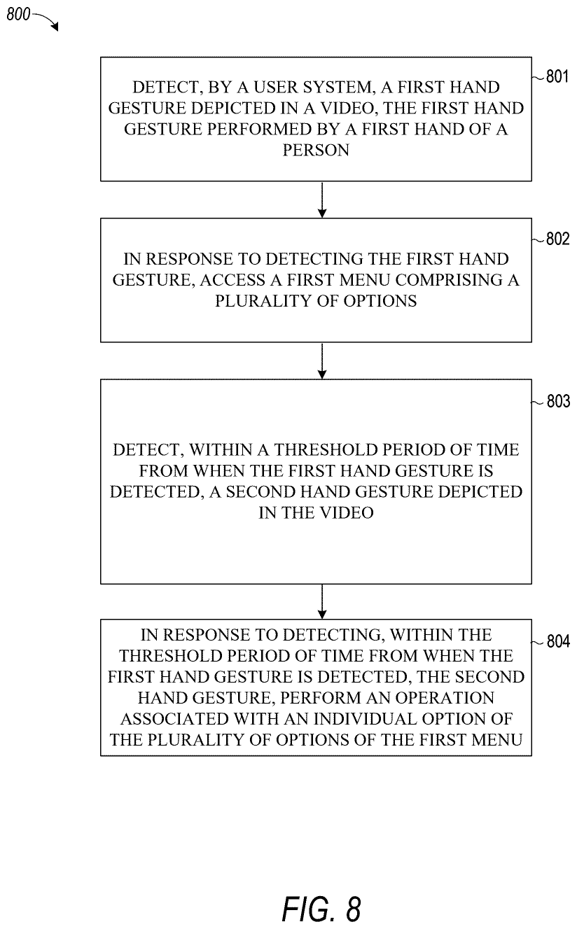

FIG. 8 is a flowchart of a process or method 800, in accordance with some examples. Although the flowchart describes the operations as a sequential process, many of the operations can be performed in parallel or concurrently. In addition, the order of the operations may be re-arranged. A process is terminated when its operations are completed. A process may correspond to a method, a procedure, and the like. The steps of methods may be performed in whole or in part, may be performed in conjunction with some or all of the steps in other methods, and may be performed by any number of different systems or any portion thereof, such as a processor included in any of the systems.

At operation 801, the hand gesture based menu navigation system 500 (e.g., a server or user system 102) detects a first hand gesture depicted in a video, the first hand gesture performed by a first hand of a person, as discussed above.

At operation 802, the hand gesture based menu navigation system 500 in response to detecting the first hand gesture, accesses a first menu comprising a plurality of options, as discussed above.

At operation 803, the hand gesture based menu navigation system 500 detects, within a threshold period of time from when the first hand gesture is detected, a second hand gesture depicted in the video, as discussed above.

At operation 804, the hand gesture based menu navigation system 500 in response to detecting, within the threshold period of time from when the first hand gesture is detected, the second hand gesture, performs an operation associated with an individual option of the plurality of options of the first menu, as discussed above.

### EXAMPLES

Example 1. A method comprising: detecting, by a user system, a first hand gesture depicted in a video, the first hand gesture performed by a first hand of a person; in response to detecting the first hand gesture, accessing a first menu comprising a plurality of options; detecting, within a threshold period of time from when the first hand gesture is detected, a second hand gesture depicted in the video; and in response to detecting, within the threshold period of time from when the first hand gesture is detected, the second hand gesture, performing an operation associated with an individual option of the plurality of options of the first menu.

Example 2. The method of Example 1, wherein the second hand gesture is performed by the first hand of the person.

Example 3. The method of Example 2, wherein the second hand gesture is performed by a second hand of the person, the first and second hand gestures being simultaneously depicted in the video.

Example 4. The method of any one of Examples 1-3, further comprising: storing a first table that associates different gestures respectively with a first set of menus, the first table being associated with a first context of the user system.

Example 5. The method of Example 4, further comprising: searching the first table to identify which of the different gestures corresponds to the first hand gesture; and identifying the first menu from the first set of menus that is associated with the first hand gesture in the first table in response to searching the table.

Example 6. The method of any one of Examples 4-5, further comprising: presenting a first augmented reality (AR) object over the first hand of the person to indicate that a current context of the user system corresponds to the first context.

Example 7. The method of Example 6, further comprising: storing a second table that associates the different gestures respectively with a second set of menus, the second table being associated with a second context of the user system; in response to detecting the first hand gesture, determining a current context of the user system; determining that the current context of the user system corresponds to the second context; and in response to determining that the current context of the user system corresponds to the second context, searching the second table instead of the first table to identify the first menu from the second set of menus associated with the first hand gesture.

Example 8. The method of Example 7, wherein the first context comprises a first application implemented on the user system, and wherein the second context comprises a second application implemented on the user system.

Example 9. The method of any one of Examples 7-8, further comprising: presenting a second AR object over the first hand of the person to indicate that the current context of the user system corresponds to the second context.

Example 10. The method of Example 9, wherein the first AR object comprises a first glove having a first visual attribute, and wherein the second AR object comprises a second glove having a second visual attribute.

Example 11. The method of any one of Examples 1-10, further comprising: presenting a list of available hand gestures corresponding to each of the plurality of options of the first menu.

Example 12. The method of any one of Examples 1-11, wherein the second hand gesture is a same gestures as the first hand gesture and causes a different operation to be performed than the first hand gesture.

Example 13. The method of any one of Examples 1-12, wherein the first and second hand gestures comprise a number of fingers raised on the first hand to represent a numerical value.

Example 14. The method of any one of Examples 1-13, further comprising: determining that the first hand gesture comprises a middle finger crossing a pointer finger, wherein the first menu comprises a settings menu associated with the first hand gesture.

Example 15. The method of any one of Examples 1-14, further comprising: determining that the second hand gesture comprises a middle finger crossing a pointer finger, wherein the operation comprises a reply or retry operation.

Example 16. The method of any one of Examples 1-15, further comprising: determining that a current context of the user system comprises a sports application; determining that the second hand gesture represents a mascot of a particular team; and in response to determining that the second hand gesture represents the mascot of the particular team and that the current context of the user system comprises the sports application, accessing sporting information associated with the particular team.

Example 17. The method of any one of Examples 1-16, further comprising: determining an intensity of the second hand gesture; and modifying the individual option faster or slower based on the intensity of the second hand gesture.

Example 18. The method of any one of Examples 1-17, wherein the operation associated with the individual option of the plurality of options of the first menu corresponds to a second menu, further comprising: detecting a third hand gesture depicted in the video; and in response to detecting the third hand gesture, performing a different operation associated with one of a set of options of the second menu.

Example 19. A system comprising: at least one processor configured to perform operations comprising: detecting, by a user system, a first hand gesture depicted in a video, the first hand gesture performed by a first hand of a person; in response to detecting the first hand gesture, accessing a first menu comprising a plurality of options; detecting, within a threshold period of time from when the first hand gesture is detected, a second hand gesture depicted in the video; and in response to detecting, within the threshold period of time from when the first hand gesture is detected, the second hand gesture, performing an operation associated with an individual option of the plurality of options of the first menu.

Example 20. A non-transitory machine-readable storage medium that includes instructions that, when executed by one or more processors of a user system, cause the user system to perform operations comprising: detecting, by a user system, a first hand gesture depicted in a video, the first hand gesture performed by a first hand of a person; in response to detecting the first hand gesture, accessing a first menu comprising a plurality of options; detecting, within a threshold period of time from when the first hand gesture is detected, a second hand gesture depicted in the video; and in response to detecting, within the threshold period of time from when the first hand gesture is detected, the second hand gesture, performing an operation associated with an individual option of the plurality of options of the first menu.

### Machine Architecture

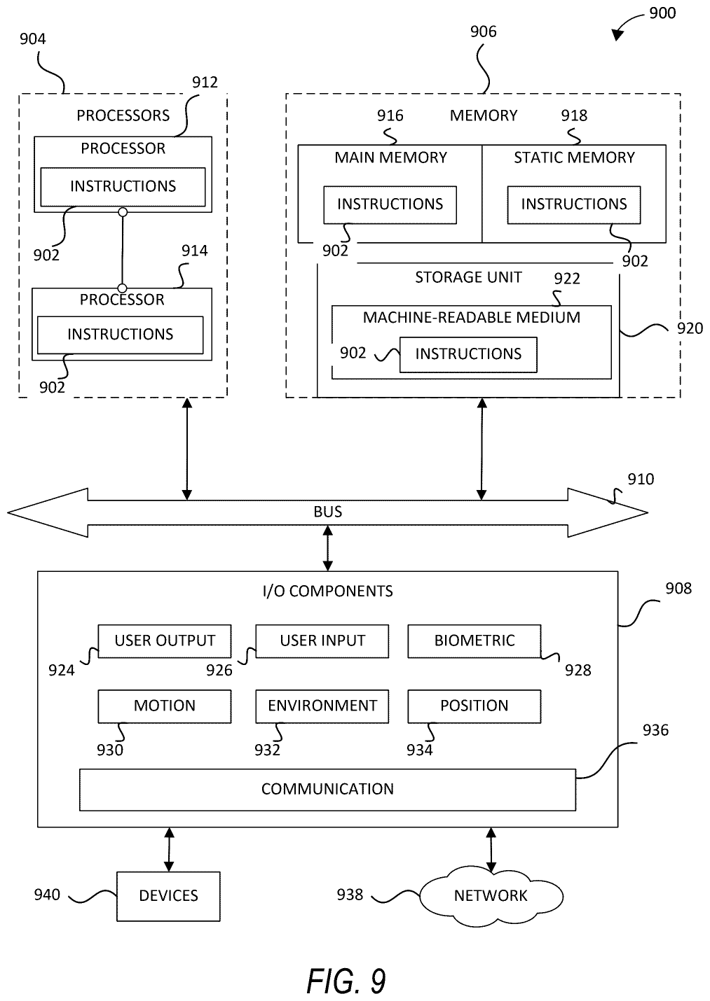

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the user system 102 or any one of multiple server devices forming part of the interaction server system 110. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output (I/O) components 908, which may be configured to communicate with each other via a bus 910. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that execute the instructions 902. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 916, a static memory 918, and a storage unit 920, both accessible to the processors 904 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 930 include acceleration sensor components (e.g., accelerometer), gravitation sensor components, rotation sensor components (e.g., gyroscope).

The environmental components 932 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad, or penta rear camera configurations on the front and rear sides of the user system 102. These multiple cameras systems may include a wide camera, an ultra-wide camera, a telephoto camera, a macro camera, and a depth sensor, for example.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 further include communication components 936 operable to couple the machine 900 to a network 938 or devices 940 via respective coupling or connections. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., HTTP). Similarly, the instructions 902 may be transmitted or received using a transmission medium via a coupling (e.g., a peer-to-peer coupling) to the devices 940.

### Software Architecture

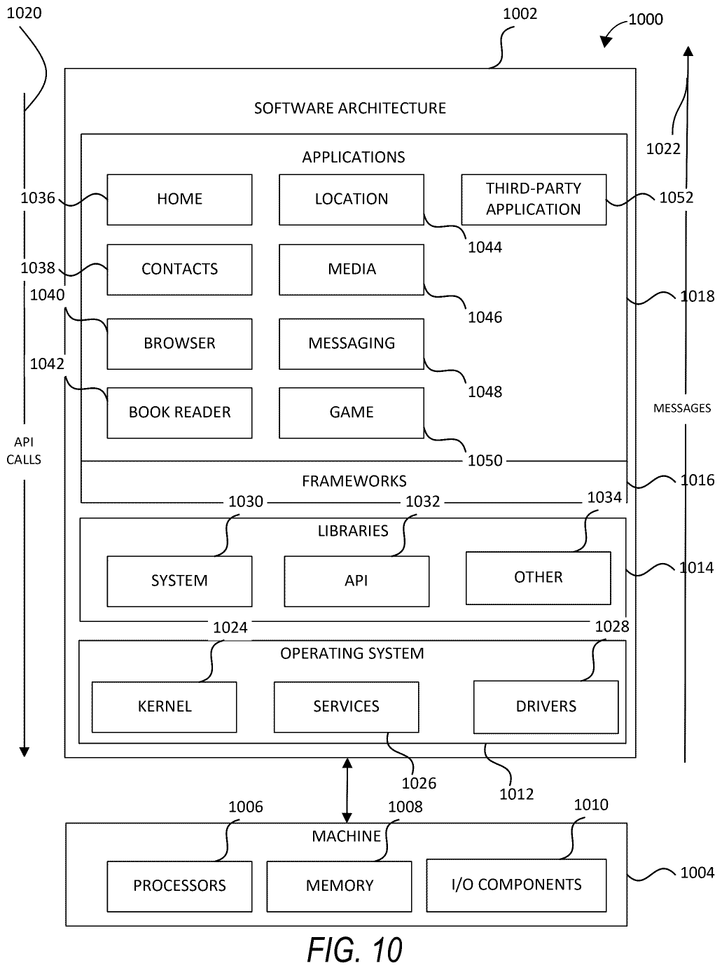

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematic functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

System with Head-Wearable Apparatus

FIG. 11 illustrates a system 1100 including a head-wearable apparatus 116 with a selector input device, according to some examples. FIG. 11 is a high-level functional block diagram of an example head-wearable apparatus 116 communicatively coupled to a mobile device 114 and various server systems 1104 (e.g., the interaction server system 110) via various networks 108.

The head-wearable apparatus 116 includes one or more cameras, each of which may be, for example, a visible light camera 1106, an infrared emitter 1108, and an infrared camera 1110.

The mobile device 114 connects with head-wearable apparatus 116 using both a low-power wireless connection 1112 and a high-speed wireless connection 1114. The mobile device 114 is also connected to the server system 1104 and the network 1116.

The head-wearable apparatus 116 further includes two image displays of the image display of optical assembly 1118. The two image displays of optical assembly 1118 include one associated with the left lateral side and one associated with the right lateral side of the head-wearable apparatus 116. The head-wearable apparatus 116 also includes an image display driver 1120, an image processor 1122, low-power circuitry 1124, and high-speed circuitry 1126. The image display of optical assembly 1118 is for presenting images and videos, including an image that can include a GUI to a user of the head-wearable apparatus 116.

The image display driver 1120 commands and controls the image display of optical assembly 1118. The image display driver 1120 may deliver image data directly to the image display of optical assembly 1118 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as PNG, JPEG, Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1128 (e.g., touch sensor or push button), including an input surface on the head-wearable apparatus 116. The user input device 1128 (e.g., touch sensor or push button) is to receive from the user an input selection to manipulate the GUI of the presented image.

The components shown in FIG. 11 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1106 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1102, which stores instructions to perform a subset or all of the functions described herein. The memory 1102 can also include a storage device.

As shown in FIG. 11, the high-speed circuitry 1126 includes a high-speed processor 1130, a memory 1102, and high-speed wireless circuitry 1132. In some examples, the image display driver 1120 is coupled to the high-speed circuitry 1126 and operated by the high-speed processor 1130 in order to drive the left and right image displays of the image display of optical assembly 1118. The high-speed processor 1130 may be any processor capable of managing high-speed communications and operation of any general computing system needed for the head-wearable apparatus 116. The high-speed processor 1130 includes processing resources needed for managing high-speed data transfers on a high-speed wireless connection 1114 to a wireless local area network (WLAN) using the high-speed wireless circuitry 1132. In certain examples, the high-speed processor 1130 executes an operating system such as a LINUX operating system or other such operating system of the head-wearable apparatus 116, and the operating system is stored in the memory 1102 for execution. In addition to any other responsibilities, the high-speed processor 1130 executing a software architecture for the head-wearable apparatus 116 is used to manage data transfers with high-speed wireless circuitry 1132. In certain examples, the high-speed wireless circuitry 1132 is configured to implement Institute of Electrical and Electronic Engineers (IEEE) 802.11 communication standards, also referred to herein as WiFi. In some examples, other high-speed communications standards may be implemented by the high-speed wireless circuitry 1132.

The low-power wireless circuitry 1134 and the high-speed wireless circuitry 1132 of the head-wearable apparatus 116 can include short-range transceivers (Bluetooth™) and wireless wide, local, or wide area network transceivers (e.g., cellular or WiFi). Mobile device 114, including the transceivers communicating via the low-power wireless connection 1112 and the high-speed wireless connection 1114, may be implemented using details of the architecture of the head-wearable apparatus 116, as can other elements of the network 1116.

The memory 1102 includes any storage device capable of storing various data and applications, including, among other things, camera data generated by the left and right visible light cameras 1106, the infrared camera 1110, and the image processor 1122, as well as images generated for display by the image display driver 1120 on the image displays of the image display of optical assembly 1118. While the memory 1102 is shown as integrated with high-speed circuitry 1126, in some examples, the memory 1102 may be an independent standalone element of the head-wearable apparatus 116. In certain such examples, electrical routing lines may provide a connection through a chip that includes the high-speed processor 1130 from the image processor 1122 or the low-power processor 1136 to the memory 1102. In some examples, the high-speed processor 1130 may manage addressing of the memory 1102 such that the low-power processor 1136 will boot the high-speed processor 1130 any time that a read or write operation involving memory 1102 is needed.

As shown in FIG. 11, the low-power processor 1136 or high-speed processor 1130 of the head-wearable apparatus 116 can be coupled to the camera (visible light camera 1106, infrared emitter 1108, or infrared camera 1110), the image display driver 1120, the user input device 1128 (e.g., touch sensor or push button), and the memory 1102.

The head-wearable apparatus 116 is connected to a host computer. For example, the head-wearable apparatus 116 is paired with the mobile device 114 via the high-speed wireless connection 1114 or connected to the server system 1104 via the network 1116. The server system 1104 may be one or more computing devices as part of a service or network computing system, for example, that includes a processor, a memory, and network communication interface to communicate over the network 1116 with the mobile device 114 and the head-wearable apparatus 116.

The mobile device 114 includes a processor and a network communication interface coupled to the processor. The network communication interface allows for communication over the network 1116, low-power wireless connection 1112, or high-speed wireless connection 1114. Mobile device 114 can further store at least portions of the instructions for generating binaural audio content in the mobile device 114's memory to implement the functionality described herein.

Output components of the head-wearable apparatus 116 include visual components, such as a display such as a LCD, a PDP, a LED display, a projector, or a waveguide. The image displays of the optical assembly are driven by the image display driver 1120. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1104, such as the user input device 1128, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a GPS receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1112 and high-speed wireless connection 1114 from the mobile device 114 via the low-power wireless circuitry 1134 or high-speed wireless circuitry 1132.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium,” and “device-readable medium” mean the same thing and may be used interchangeably in this disclosure. “Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” and “computer-storage medium” mean the same thing and may be used interchangeably in this disclosure.

The terms “machine-storage media,” “computer-storage media,” and “device-storage media” specifically exclude carrier waves, modulated data signals, and other such media, at least some of which are covered under the term “signal medium.” “Non-transitory computer-readable storage medium” refers, for example, to a tangible medium that is capable of storing, encoding, or carrying the instructions for execution by a machine. “Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems. “Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device. “Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. Any mention of the term “module” herein applies similarly to “component” and the two terms should be understood to have the same meaning.

Changes and modifications may be made to the disclosed examples without departing from the scope of the present disclosure. These and other changes or modifications are intended to be included within the scope of the present disclosure, as expressed in the following claims.

What is claimed is:

1. A method comprising:
detecting, by a user system, a first hand gesture depicted in a video, the first hand gesture performed by a first hand of a person;
in response to detecting the first hand gesture, accessing a first menu comprising a plurality of options;
detecting, within a threshold period of time from when the first hand gesture is detected, a second hand gesture depicted in the video; and
in response to detecting, within the threshold period of time from when the first hand gesture is detected, the second hand gesture, performing an operation associated with an individual option of the plurality of options of the first menu.

2. The method of claim 1, wherein the second hand gesture is performed by the first hand of the person.

3. The method of claim 2, wherein the second hand gesture is performed by a second hand of the person, the first and second hand gestures being simultaneously depicted in the video.

4. The method of claim 1, further comprising:
storing a first table that associates different gestures respectively with a first set of menus, the first table being associated with a first context of the user system.

5. The method of claim 4, further comprising:
searching the first table to identify which of the different gestures corresponds to the first hand gesture; and
identifying the first menu from the first set of menus that is associated with the first hand gesture in the first table in response to searching the table.

6. The method of claim 4, further comprising:
presenting a first augmented reality (AR) object over the first hand of the person to indicate that a current context of the user system corresponds to the first context.

7. The method of claim 6, further comprising:
storing a second table that associates the different gestures respectively with a second set of menus, the second table being associated with a second context of the user system;
in response to detecting the first hand gesture, determining a current context of the user system;
determining that the current context of the user system corresponds to the second context; and
in response to determining that the current context of the user system corresponds to the second context, searching the second table instead of the first table to identify the first menu from the second set of menus associated with the first hand gesture.

8. The method of claim 7, wherein the first context comprises a first application implemented on the user system, and wherein the second context comprises a second application implemented on the user system.

9. The method of claim 7, further comprising:
presenting a second AR object over the first hand of the person to indicate that the current context of the user system corresponds to the second context.

10. The method of claim 9, wherein the first AR object comprises a first glove having a first visual attribute, and wherein the second AR object comprises a second glove having a second visual attribute.

11. The method of claim 1, further comprising:
presenting a list of available hand gestures corresponding to each of the plurality of options of the first menu.

12. The method of claim 1, wherein the second hand gesture is a same gestures as the first hand gesture and causes a different operation to be performed than the first hand gesture.

13. The method of claim 1, wherein the first and second hand gestures comprise a number of fingers raised on the first hand to represent a numerical value.

14. The method of claim 1, further comprising:
determining that the first hand gesture comprises a middle finger crossing a pointer finger, wherein the first menu comprises a settings menu associated with the first hand gesture.

15. The method of claim 1, further comprising:
determining that the second hand gesture comprises a middle finger crossing a pointer finger, wherein the operation comprises a reply or retry operation.

16. The method of claim 1, further comprising:
determining that a current context of the user system comprises a sports application;
determining that the second hand gesture represents a mascot of a particular team; and
in response to determining that the second hand gesture represents the mascot of the particular team and that the current context of the user system comprises the sports application, accessing sporting information associated with the particular team.

17. The method of claim 1, further comprising:
determining an intensity of the second hand gesture; and
modifying the individual option faster or slower based on the intensity of the second hand gesture.

18. The method of claim 1, wherein the operation associated with the individual option of the plurality of options of the first menu corresponds to a second menu, further comprising:
detecting a third hand gesture depicted in the video; and
in response to detecting the third hand gesture, performing a different operation associated with one of a set of options of the second menu.

19. A system comprising:
at least one processor configured to perform operations comprising:
detecting, by a user system, a first hand gesture depicted in a video, the first hand gesture performed by a first hand of a person;
in response to detecting the first hand gesture, accessing a first menu comprising a plurality of options;
detecting, within a threshold period of time from when the first hand gesture is detected, a second hand gesture depicted in the video; and
in response to detecting, within the threshold period of time from when the first hand gesture is detected, the second hand gesture, performing an operation associated with an individual option of the plurality of options of the first menu.

20. A non-transitory machine-readable storage medium that includes instructions that, when executed by one or more processors of a user system, cause the user system to perform operations comprising:
detecting, by a user system, a first hand gesture depicted in a video, the first hand gesture performed by a first hand of a person;
in response to detecting the first hand gesture, accessing a first menu comprising a plurality of options;
detecting, within a threshold period of time from when the first hand gesture is detected, a second hand gesture depicted in the video; and
in response to detecting, within the threshold period of time from when the first hand gesture is detected, the second hand gesture, performing an operation associated with an individual option of the plurality of options of the first menu.
